(19) United States
(12) Patent Application Publication
(10) Pub. No.: US 2006/0135386 A1
(43) Pub. Date: Jun. 22, 2006

(54) Chemical composition for a fire retardant textile

(76) Inventor: Larry Rising, Kernersville, NC (US)

Correspondence Address: Larry Rising, 3820 Firestone Road, Kernersville, NC, 27284, US

(21) Appl. No.: 11/355,270

(22) Filed: Feb. 15, 2006

Related U.S. Application Data
(62) Division of application No. 10/611,746, filed on Jun. 30, 2003, now abandoned.

(51) Int. Cl. C11D 7/32

(52) U.S. Cl. 510/175; 510/285; 510/412

(57) ABSTRACT

The present invention relates to methods and chemical compositions utilizing NPB (n-propyl bromide) also called 1-bromopropane or propyl bromide or 1-BP or N-Bromopropane as non-aqueous carrier mediums to apply fire retardants, fluorocarbons and other chemicals to substrates, whereby the NPB is evaporated away leaving the remaining chemicals on the substrate. The present invention offers compositions and method for applying organic chemicals to substrates that perform superior to current water based technology. Additional, the invention offers a more economical and environmental friendly alternative to current chlorinated hydrocarbons carriers that are being phased out by mandate of the Environmental Protection Agency (EPA).

### OTHER REFERENCES

Chem. Abst., 66, 76542m (1967). Fluorine-containing compositions for treating substrates to render them oil-, water- and soil-repellant, comprising A fluorine-containing acrylic copolymer and a fluorine-free poly (meth) acryl ate.

This application is a divisional of U.S. patent application Ser. No. 10/611,746 filed Jun. 30, 2003. Titled “Chemical formulations and methods utilizing NPB (n-propyl bromide) as non-aqueous carrier mediums to apply fluorocarbons and other organic chemicals to substrates” which is incorporated by reference in its entirety herein.

### BACKGROUND OF THE INVENTION

NPB (n-propyl bromide) has been used in the metal parts degreasing industry, particularly in vapor degreasers for years. Now according to the invention it has been discovered to have a very useful and desired purpose in other industries. Many substrates, for example, home textiles, carpets, upholstery acquire oil-, water- and soil-repellant properties by treatment with fluorocarbons.

These chemicals are now applied to substrates with water based (aqueous) carriers requiring other auxiliary chemicals i.e.: emulsifiers and dispersing agents to keep organics in suspension. These auxiliary chemicals needed for aqueous application often lesson the intended benefit of the applied chemical to the substrate. These aqueous carriers require high temperatures and expensive drying systems to evaporate the water. Chlorinated hydrocarbons have been used in the past as carrier mediums to apply organic chemicals to substrates when an aqueous carrier could not be used. Chlorinated hydrocarbons are being phased out by mandate of the Environmental Protection Agency (EPA).

### BRIEF SUMMERY OF THE INVENTION

By this invention, NPB has shown an excellent alternative to current aqueous and chlorinated hydrocarbons as a carrier medium for application of organics to substrates. NPB is non-regulated, non-toxic and has no ozone pollution properties. NPB is economical and environmentally friendly.

The invention relates to compositions for providing one or more fire retardant properties to, or for enhancing one or more fire retardant properties of, substrates containing at least 5 weight percent of non-thermoplastic material, such as non-thermoplastic filaments, microfibers, fibers, fibrous compositions, threads, yarns, fabrics, textiles, materials, items of apparel, paper or tissue, or blends or products produced using any of the foregoing materials, and to substrates treated in accordance with the processes, systems or compositions of the invention.

After extensive study, it has been found that the use of NPB as a carrier dramatically improves the performances and durability of benefits achieved by application of organics to substrate and that this invention is superior to current methods and chemistry.

### DETAILED DESCRIPTION OF THE PREFERRED EMBODIMENTS

The invention relates to methods and formulations to provide substrates with treatment to include fire retardant treatment, for example; the treatment of home textiles and apparel, which achieve desired effects with significantly smaller amounts of expensive fire retardant compounds as compared to available current technology, as illustrated in Example 2 compared to Example 4.

The following description, taken in conjunction with the referenced examples, is presented to enable one of ordinary skill in the art to make and use the invention. Various modifications will be readily apparent to those Skilled in the art, and the general principles defined herein may be applied to a wide range of aspects. Thus, the present invention is not intended to be limited to the aspects presented, but is to be accorded the widest scope consistent with the principles and novel features disclosed herein. Furthermore, the compositions according to the invention should furthermore impart to the substrates, in particular the home textiles, water-repellant actions that meet increased requirements.

Another object comprises providing treatment compositions with which the heat treatment or curing can be carried out at the lowest temperature or, preferably, no heat treatment is necessary (Example 3).

In one aspect, invention relates to substrates from the group consisting of naturally occurring and synthetic textiles and their mixtures, leather, mineral substances, thermoplastic and thermosetting polymers and paper, which are treated with fluorine-containing compositions of the type mentioned below in an amount of 10 to 10,000 ppm, preferably 50 to 5,000 ppm, particularly preferably 100 to 2,000 ppm, calculated based on the total weight of substrates provided wit treatment.

In another aspect, other textile auxiliary chemicals can be added during preparation of the treatment formula as according to the invention, or subsequently. Such additives are crease-proofing and soft handle agents, melamine, water and oil repellent, oleophobizing agents, hydrophobizing agents, Urethane, finishing agents, extenders for textile auxiliaries and others.

Substrates which are suitable for treatment according to the invention are: linen, cotton, wool, silk, jute, polyamide, polyester, polyacrylonitrile and mixtures thereof, leather, stone slabs, floor tiles, glazed tiles, roof tiles, glass, ground surfaces of silicon, foils and films and compact work pieces of polyolefin's, polyesters, polyamides, polycarbonates, polyurethane, polyacetals, polyethers, polysulphides, polysulphones, polyamides and other thermoplastics, as well as of phenol/formaldehyde resins, urea/formaldehyde resins, melamine/formaldehyde resins and other thermosetting resins, paper and paper-like materials, such as paperboard. Preferred base substrates are home textiles based on naturally occurring and synthetic textiles and their mixtures, which are employed, for example, as carpets, curtains, decorative materials or coverings for upholstered furniture.

Processes for the treatment of such base substrates and therefore for application of the compositions according to the invention are known to the expert and are, for example, foaming, dipping or spraying of the base substrates; the compositions according to the invention furthermore can be employed during the production of the base substrates, for example the pulp.

Textiles as base substrates, preferably home textiles and apparel can be treated, for example, in the padding, spraying or foaming process. The padder consists of a liquor trough (chassis) and at least one pair of rubber rolls (Example 2). The textiles to be treated are impregnated with the treatment liquor in the chassis and squeezed off between the rolls; the liquor runs back into the chassis. It is very important that a uniform liquor pick-up is achieved over the entire width of the goods during squeezing-off.

In the padding process, the liquor pick-up is stated in percentage of the weight of goods, and for normal textile constructions can be between 30 and 300%, depending on the quality of the goods and the padder pressure used.

In the spraying process, (Example 3) the textile is sprayed with the treatment liquor. The treatment liquor is finely divided by nozzles and applied uniformly. An amount of treatment liquor precisely defined beforehand is applied to one square meter of textile goods.

In the foaming process, the treatment liquor is continuously foamed mechanically in a commercially available mixer with out the addition of a foaming agent. The foam is produced in the mixing head by mixing the liquor with air. The foam, which emerges, is conveyed via a foam line to a discharge slot in the applicator. The goods are pressed against the slot and taken off via a separate unit, for example a stenter frame. In example 1, a concentration of 92% NPB and 6% retardant treatments with 2% foaming aid were carried out on the Gaston Systems, Inc. Foam Generation and Application system, Stanly, N.C.

By the invention, it has been discovered surprisingly that a mixture of NPB Fire retardant and Perfluoroalkyl polyacrylate as foaming aid can be foamed without the aid of a foaming agent (Example 1). Not using foaming agents greatly improves the benefit of the applied composition to the substrate and reduces the amount of compound added to fabric to achieve properties.

In prior art, fire retardants are used in the textile industry. However, they generally applied by dip and squeeze and produce limited results, because they are used in suspension form. According to the invention, the non-aqueous solution of fire retardants are in solution with NPB, optionally with complementary components, is applied to textile materials and penetrates into the fibers, and then polymerization is effected by heating at temperatures above 230.degree. F., thus polymerizing and binding the resulting polymers and retardants to the fibers.

According to the invention retardants can be applied with (meth) acrylate derivatives, such as butyl acrylate, methyl methacrylate or other monomers, to produce transparent plastics bonding retardants to the fiber.

In another aspect, this invention involves the surprising discovery that the use of NPB with retardants via dipping and squeezing with pressure rollers (Padding) and the NPB being evaporated away imparts a much improved softness and luster to treated textile substrates, especially home furnishing, apparel fabrics and upholstery fabrics.

After the treatment, the textiles, preferably home textiles, are dried, it being possible to use temperatures of 120.degree. To 170.degree. C. to achieve the desired treatment effect according to the known procedure. However, good treatments can also be obtained with the new compositions according to the invention at significantly lower drying temperatures, for example at 25.degree. C. (Example 3).

Samples of the materials thus pretreated were taken for testing of the following effects:

Oil-repellency (according to AATCC 118-1972): The test sample is placed on a horizontal, smooth surface, a small drop (drop diameter about 5 mm) of he test liquids is applied to the test sample with the aid of a dropping pipette, In addition, the sample is evaluated as specified.

The AATCC oil-repellency level of a test fabric is the highest number of that test liquid which does not wet or penetrate into the test material within a time span of 30 seconds. The test liquids and mixtures for the test method are: No. 1: Nujol or paraffin oil DAB 8; No. 2: 65% by volume of Nujol and 35% by volume of n-hexadecane; No. 3: n-hexadecane; No. 4: n-tetradecane; No. 5: n-dodecane; No. 6: n-decane; No. 7: n-octane; No. 8: n-heptane.

Repellency towards a water/alcohol mixture (hydrophobicity): Drops of water/isopropanol mixtures (ratio 90/10 to 10/90) are applied to the test sample. The test result corresponds to the mixture with the highest isopropanol content which remains on the test sample in unchanged form for at least 20 seconds (the value 80/20, for example, is better than 20/80).

### EXAMPLES

Compositions which are not according to the invention (Example 4) and which represent the prior art are the following: Nuva HPU (Clariant Corporation). Scotchgard.RTM. FC 396 (3M Comp.) according to DE-A 2 149 292 Baygard.RTM. SF-A. (Bayer AG) according to DE-A 3 307 420 and Zonyl (E.I. Dupont)

The compositions according to the invention (Example 1) is a non-aqueous solution, contents of which comprise a mixture of NPB (component A) and one or more fire retardants (component B) and optionally (component C) one or more poly (meth) acrylates with cross linker.

### Use of the Compositions According to the Invention:

### Example 1

91.8% NPB, 6% alkyl phosphate, 2% tribromoneopentyl alcohol and .2% perfluoroalkyl polyacrylate. Solution foamed at 20:1 blow ratio until a stable foam was achieve ( Approximately 3 minutes).

Fabric without flame retardants was placed into a pin frame and completely covered with a foamed non-aqueous solution according to the invention described in EXAMPLE 1 at 50% wet pick-up and dried at 230 deg F. for 2 minutes.

The dried fabric was then flame tested using the NFPA 701 test. The char length of the dried flame retarded fabric was determined to be less than 3 inches. Thus, this treated substrate also passed the NFPA 701 test. Additionally, there was no after flame, indicating that the substrate had good fire resistance, and that the induced flame was self extinguishing.

### Example 2

A solution of 99.6% NPB and .4% Perfluoroalkyl polyacrylate were mixed and applied to the substrates listed below via a pad applicator at 3.5 bars pressure. The solution was applied at noted wet pickup. Again, the substrates were dried at 170 deg C. with a 1-minute dwell.

| Initial | | | | | After 10 Home Laundries | | | |
|---|---|---|---|---|---|---|---|---|
| Example 2 | Oil | IPA | Spray | Fluoride | Oil | IPA | Spray | Fluoride |
| Cotton | 6 | 100 | 100 | 2480 ppm | 3 | 90 | 80 | 2200 ppm |
| Polyester | 8 | 90 | 100 | 1270 ppm | 6 | 90 | 90 | 1100 ppm |
| Pes/Rayon | 8 | 80 | 100 | | 6 | 80 | 80 | |

### Example 3

A solution of 99.6% NPB and 2% Perfluoroalkyl polyacrylate were mixed and applied to the substrates listed below via a Spray at 1.5 bars pressure. The solution was applied at noted wet pickup. Again, the substrates were dried at 170 deg C. with a 1-minute dwell.

| Initial | | | | | After 10 Home Laundries | | | |
|---|---|---|---|---|---|---|---|---|
| Example 3 | Oil | IPA | Spray | Fluoride | Oil | IPA | Spray | Fluoride |
| Cotton | 6 | 85 | 100 | 2260 ppm | 2 | 60 | 70 | 1690 ppm |
| Polyester | 6 | 90 | 100 | 1170 ppm | 5 | 90 | 90 | 1080 ppm |
| Pes/Rayon | 6 | 80 | 100 | | 5 | 60 | 70 | |

### Use of the Compositions not According to the Invention

### Example 4

An aqueous Perfluoroalkyl polyacrylate dispersion using Nuva HPU at 2% concentration was prepared and applied via a padding applicator at 3.5 bars pressure. The solution was applied at noted wet pickup. Again, the substrates were dried at 170 deg C. with a 1-minute dwell.

| Initial | | | | | After 10 Home Laundries | | | |
|---|---|---|---|---|---|---|---|---|
| Example 4 | Oil | IPA | Spray | Fluoride | Oil | IPA | Spray | Fluoride |
| Cotton | 7 | 100 | 100 | 2460 | 7 | 90 | 80 | 2210 |
| | | | | ppm | | | | ppm |
| Polyester | 6 | 60 | 100 | 1270 | 4-5 | 45-50 | 90 | 1100 |
| | | | | ppm | | | | ppm |
| Pes/ | 5 | 60 | 100 | | 2 | 35-40 | 70 | |
| Rayon | | | | | | | | |

In all examples, the substrates used were (1) White Polyester 8oz/sq yd (PES), (2) 100% Cotton interlock and (3) 60/40 PES and Rayon Blend.

1. Chemical formulations comprising component (A) NPB (n-propyl bromide) as a non-aqueous carrier medium to apply component (B) fluorocarbons to textile and non-woven substrates, whereby the NPB is evaporated leaving the remaining fluorocarbon on the substrate. The said fluorocarbon being selected from the group:
polyvinylidene fluoride;
polytetrafluoroethylene;
perfluoroalkylethyl acrylates;
perfluoroalkylethyl methacrylates;
mixtures of the same; and
blends of the foregoing compounds and polymers with polyalkyl acrylates, polyalkyl methacrylates, and copolymers of vinylidene chloride, vinylidene fluoride, tetrafluoroethylene, perfluoroalkylethyl acrylates, and perfluoroalkylethyl methacrylates, and wherein the said fluorocarbon is 0.002% to 4% by weight of the base weight of the substrate.

2-15. (canceled)

16. Composition as set forth in claim 1, whereby (B) is selected from the group fire retardant compositions comprising one or more of:
alkyl phosphate, tribromoneopentyl alcohol, alkyl phosphate, borates such as boric acid, zinc borate or borax;
tribromoneopentyl alcohol;
sulfamates;
phosphates such as ammonium polyphosphate;
organic phosphorous compounds;
halogenated compounds such as ammonium bromide, decabromodiphenyl oxide, or chlorinated paraffin;
inorganic hydroxides such as aluminum or magnesium hydroxide, antimony compounds, and silica or silicates, which comprises, based on the total weight of A, the following weight contents of comonomer (B): is 0.002% to 25% by weight of component A.

17. Chemical formulations comprising (A) NPB (n-propyl bromide), and (B) a coating component, and (C) a cross linking, extender or other component, whereas the said NPB is used as a medium to apply components (B) and (C), and whereby the NPB is evaporated away leaving the remaining (B) and (C) chemicals on a textile or non-woven substrate.

18. Composition as set forth in claim 17, whereby component (B) is selected from the group fluorochemicals, wherein said fluorochemical is selected from the group:
polyvinylidene fluoride;
polytetrafluoroethylene;
perfluoroalkylethyl acrylates;
perfluoroalkylethyl methacrylates;
mixtures of the same; and
blends of the foregoing compounds and polymers with polyalkyl acrylates, polyalkyl methacrylates, and copolymers of vinylidene chloride, vinylidene fluoride, tetrafluoroethylene, perfluoroalkylethyl acrylates, and perfluoroalkylethyl methacrylates, and wherein component (B) is 0.002% to 40% by weight of component (A), and whereby component (C) is a cross-linking or extender component, wherein said component (C) is selected from the group comprising one or more of the following: melamine formaldehydes and derivatives, trimethylolmelamine, hexamethylolmelamine, epoxides, anhydrides and derivatives thereof. Derivatives of isocyanates, diisocyanates. Polymers containing two or more blocked isocyanate compounds or aromatic blocked isocyanates. Monomers or polymers containing isocyanate compounds. whereas said component (C) is .001% to 20% by weight of component A

19. Composition as set forth in claim 17, whereby component (B) is an oligomer polymer resin selected from the group consisting of aliphatic urethane acrylates;
aliphatic urethane diacrylates;
aliphatic urethane triacrylates;
hexafunctional aliphatic urethane acrylates;
hexafunctional aromatic urethane acrylates;
trifunctional aromatic urethane acrylates, aromatic urethane acrylates;
urethane methacrylates;
epoxy acrylates;
epoxy methacrylates;
polybutadiene dimethylacrylates;
diacrylates of bisphenol-A epoxy resins;
modified bisphenol-A epoxy acrylate resins;
novolac epoxy acrylates;
modified epoxy acrylates;
partially acrylated bisphenol-A epoxy resins;
bisphenol-A epoxy diacrylates;
polyester resins;
cycloaliphatic epoxide resins;
modified cycloaliphatic epoxides;
aliphatic polyols;
partially acrylated bisphenol-A epoxy resins, whereby based on the total weight of A, the following weight contents of comonomer (B): is 0.002% to 40% by weight of component A, and wherein component (C) is an antibacterial component comprising of one or more organic antimicrobial agents to include, silver-containing resins, silver-containing zeolites, silver-containing glass, silver-based ion exchange compounds, triclosan, inorganic antimicrobial materials, metal based zeolites, metal salts, metal oxides, metal hydroxides, transition metal ions, zinc oxide, pyrithione containing materials, tributyl oxide derivatives, 3-iodo-2-propylbutyl carbamate, n-butyl-1,2 benzisothiazoline, 10, 10′-oxybisphenoxi arsine, sodium o-phenylphenate, whereby said component (C) is .001% to 4% by weight of component (A).

20. Composition as set forth in claim 18, for foaming applications, whereby component (B) is 1% to 20% by weight of component A.

21. Composition as set forth in claim 1, for foaming applications whereby component (B) is 1% to 20% by weight of component A.

22. Composition as set forth in claim 1, whereby (B) is selected from the group fire retardant compositions comprising one or more of:
alkyl phosphate, tribromoneopentyl alcohol, alkyl phosphate, borates such as boric acid, zinc-borate or borax;
tribromoneopentyl alcohol;
sulfamates;
phosphates such as ammonium polyphosphate;
organic phosphorous compounds;
halogenated compounds such as ammonium bromide, decabromodiphenyl oxide, or chlorinated paraffin;
inorganic hydroxides such as aluminum or magnesium hydroxide, antimony compounds, and silica or silicates, which comprises, based on the total weight of A, the following weight contents of comonomer (B): 0.002% to 25% by weight of component A, and, whereby component (C) is an antibacterial component comprising of one or more organic antimicrobial agents to include, silver-containingresins, silver-containing zeolites, silver-containing glass, silver-based ion exchange compounds, triclosan, inorganic antimicrobial materials, metal based zeolites, metal salts, metal oxides, metal hydroxides, transition metal ions, zinc oxide, pyrithione containing materials, tributyl oxide derivatives, 3-iodo-2-propylbutyl carbamate, n-butyl-1,2 benzisothiazoline, 10,10′-oxybisphenoxi arsine, sodium o-phenylphenate, whereby said component (C) is .001% to 4% by weight of component (A).

23. Composition as set forth in claim 1, whereby (B) is comprised of a (meth) acrylate containing a perfluoroalkyl group, and wherein component (B) is 0.001% to 20% by weight of component (A). Component (C) is selected from the group hyhrophobic cross-linkers containing one or more of the following:
melamine formaldehydes and derivatives, trimethylolmelamine, hexamethylolmelamine, epoxides, anhydrides and derivatives thereof. Derivatives of isocyanates, diisocyanates. Polymers containing two or more blocked isocyanate compounds or aromatic blocked isocyanates. Monomers or polymers containing isocyanate compounds. whereby said component (C) is .001% to 20% by weight of component A.

24. Composition for treating textile and non-woven substrates by the composition, stabilized NPB, whereby the said stabilized NPB is utilized to dissolve and remove contaminants from the said substrates.
